(19) United States
(12) Patent Application Publication
(10) Pub. No.: US 2010/0009840 A1
(43) Pub. Date: Jan. 14, 2010

(54) CEMENT-FREE REFRACTORY

(76) Inventors: Robert A. Pattillo, Birmingham, AL (US); Sam Bonsall, Bowling Green, OH (US)

Correspondence Address: Vesuvius Crucible Company, 250 Park West Drive, Pittsburgh, PA, 15275, US

(21) Appl. No.: 12/307,627

(22) PCT Filed: Jul. 6, 2007
(86) PCT No.: PCT/US07/72927

§ 371 Date: Jan. 6, 2009

Related U.S. Application Data
(60) Provisional application No. 60/818,799, filed on Jul. 6, 2006.

(51) Int. Cl. C04B 35/48; C04B 35/14; C04B 35/10; C04B 35/03

(52) U.S. Cl. 501/103; 501/133; 501/128; 501/122; 501/123

(57) ABSTRACT

The present invention describes a cement free refractory mixture. The mixture comprises a pH buffer and a component containing a metal or fumed silica. Water may impart good flow characteristics to the mixture and can produce an effective low temperature cure. At elevated temperatures, an article formed using this mixture has superior refractory and physical properties.

### FIELD OF THE INVENTION

The invention relates to a refractory mixture. The mixture contains a pH buffer and fumed silica or silicon metal. The mixture can be formed by conventional techniques to create a refractory article. The article can have superior physical properties, including greater refractoriness, than materials having cement-based or chemical binders.

### BACKGROUND OF THE INVENTION

Refractory articles include both pre-formed products and products that are shaped in situ. Pre-formed products include shrouds, tubes, plates, and bricks. Formed products may be used as linings for vessels, tubes or channels, and are often provided as a mixture that may be rammed, gunned, trowelled, sprayed, vibrated or cast in place.

Refractory articles must resist thermal, chemical and mechanical attacks. Thermal attacks include high temperature, often above 1000 C., and thermal shock caused by quickly changing the temperature of the article. Frequently, the application in which the article is used includes or generates damaging chemicals. For example, slag present in steel casting chemically attacks the refractory articles so that articles in contact with slag often include slag-resistant oxides, such as zirconia. Similarly, refractory tubes used in aluminum-killed steels must resist a build-up of alumina that could otherwise clog the tube. Finally, the refractory article must be strong enough to resist mechanical forces, such as compressive, tensile and torsional stresses.

Commonly, refractory articles are formed from a combination of refractory aggregate and a binder. The binder holds the aggregate in place. Both the aggregate and binder can profoundly affect the properties of the article. Common aggregates include silica, zirconia, silicon carbide, alumina, magnesia, spinels, calcined dolomite, chrome magnesite, olivine, forsterite, mullite, kyanmite, andalusite, chamotte, carbon, chromite, and their combinations.

Binders have fallen into two broad classes, cementitious and “chemical.” Chemical binders include organic and inorganic chemicals, such as phenols, furfural, organic resins, phosphates and silicates. The article must often be fired to activate the chemical and initiate the binder. Cementitious binders include cement or other hydratable ceramic powders, such as calcium aluminate cement or hydratable alumina. They usually do not require heating to activate the binder but do require the addition of water. Water reacts with the cementitious binder to harden the mixture. Water also serves as a dispersing medium for the fine powders. Dry powders have poor flowability and are not suitable for forming refractory articles in the absence of high pressure. Water reduces the viscosity of the mixture, thereby permitting the aggregate/binder mixture to flow. Unfortunately, the presence of water in a refractory article can have disastrous effects, namely cracking of the article when exposed to elevated temperatures and even explosive vaporization at refractory temperatures. An article having a cementitious binder often requires a drying step to eliminate residual water.

A refractory aggregate/binder mixture typically includes at least 70 wt. % aggregate and up to about 15 wt. % cement binder. Water is added to make up the balance of the mixture in a quantity sufficient to produce the desired flow for forming a refractory article. Water can be added directly or as a hydrate. For example, European Patent Application Publication No. 0064863 adds water as an inorganic hydrate that decomposes at elevated temperatures. U.S. Pat. No. 6,284,688 includes water in micro-encapsulated sodium silicate.

The porosity of the article affects the drying speed and the danger of explosive vaporization, in that pores permit water to evaporate or volatilize from the article. Prior art has increased porosity of the mixture by the addition of metal powders. JP 38154/1986 teaches a refractory mixture comprising aggregate, cement and aluminum powder. The aluminum powder reacts with added water to produce hydrogen gas. The bubbling gas forms pores through which drying can occur and steam can be released. The aluminum reaction produces copious amounts of heat that further aid in drying. Problems with aluminum powder include the strong exothermic quality of the reaction, release of inflammable hydrogen gas, formation of microcracks in the article, and limited shelf life of the aluminum powder. In order to control this reactivity, U.S. Pat. No. 5,783,510 and U.S. Pat. No. 6,117,373 teach a monolithic refractory composition comprising refractory aggregate, refractory powder, and reactive metal powder. The refractory powder includes aluminous cement to bond the aggregate, thereby imparting physical strength to an article formed by the composition. The reactive metal includes aluminum, magnesium, silicon and their alloys. The amount of reactive metal is selected to control generation of hydrogen gas and, thereby the porosity. Alternatively, Japanese Unexamined Patent Publication No. 190276/1984 teaches the use of fibers to form fine channels through which water can escape. Unfortunately, fibers are difficult to disperse uniformly in the mixture and decrease flowability. The porosity of the article is also increased with deleterious effects on physical properties of the finished article.

Refractory articles may include a chemical, that is, non-cementitious, binder that can eliminate the need for water. Viscosity is typically very high and aggregate/chemical binder mixtures often do not flow well. Chemical binders are typically activated by heating or firing at elevated temperatures, and are used, for example, in dry vibratable mixtures and many pre-formed articles. U.S. Pat. No. 6,846,763 includes granulated bitumen as a binder, along with refractory aggregate, an ignitable metal powder, and oil. Heating the mixture ignites the metal powder, which burns the oil, and melts and cokes the bitumen. The result is a carbon-bonded refractory article. A typical composition includes 70 wt. % aggregate, 6 wt. % silicon, 7 wt. % oil and 13 wt. % bitumen. Although requiring high temperature to form the carbon-bond, the article is substantially water-free. Carbon-bonded articles are not as stable as oxide-bonded articles. Unless held in a reducing atmosphere, carbon-bonded articles are also susceptible to oxidation at elevated temperature.

U.S. Pat. No. 5,366,944 teaches a refractory composition using both low temperature and high temperature binders. Water is not added to the composition. The low temperature binder includes organic binders such as phenolic resins. The high temperature binder includes a metal powder of aluminum, silicon, magnesium, their alloys and mixtures. An article can be formed from the composition and cured at low temperature to activate the low temperature binder. The low temperature binder holds the article together until the article is installed and the high temperature binder activates. The metal binder cannot activate until refractory temperatures are achieved. Advantageously, the metal binder produces an article of higher refractoriness than cement-based binders.

A need exists for a non-cement-based refractory mixture having low water content and low porosity, producing refractory articles with high strength at high temperatures.

### SUMMARY OF THE INVENTION

The present invention relates to a mixture yielding refractory compositions that are useful, for example, as linings for various metallurgical vessels, such as furnaces, ladles, tundishes, and crucibles. The compositions may also be used for articles, in whole or part, that direct the flow of liquid metals. The mixture needs less water than traditional cement-based systems, thereby reducing drying times and the risk of explosion. The mixture does not require firing to achieve an initial cure. Advantageously, the mixture also increases refractoriness and strength of the resultant article when compared to cement-based mixtures.

In a broad aspect, the invention includes a cement-free mixture of a refractory aggregate and a substance producing a pH buffer. The mixture may contain a binder containing a finely powdered metal component. The application dictates the choice and gradation of raw materials, such as the chemical composition and particle size of the refractory aggregate and binder. An aggregate component with a large surface area, such as fumed silica, is believed to produce a gel that acts in the formation of a refractory material with low water content and low water porosity. References herein to fumed silica as an aggregate component are understood to pertain to dry fumed silica, as distinguished from colloidal silica. The presence of a substance producing a pH buffer, such as magnesia, alumina, zirconia or non-cementitious calcium compounds, or combinations of these materials, is also believed to act to form a refractory material with low water content and low water porosity.

The mixture of the invention requires less water than do traditional cement-based mixtures. Further, the addition of a given amount of water to the aggregate/binder mixture results in greater flowability than cement-based mixtures. Physical properties of the article are also less dependent on the amount of water added than cement-based articles.

In one embodiment, a mixture comprises a refractory aggregate and from 0.5 wt. % to 5 wt. % metal powder having a particle size of −200 mesh or finer. A sufficient amount of water is added to the mixture depending on the application. The pH of the mixture is adjusted so that evolution of hydrogen gas is prevented or reduced to an acceptable low level. Buffering agents, as known by one of ordinary skill in the art, can be used to maintain pH. Optionally, a deflocculant may be added to improve flow characteristics or reduce water requirements. The aggregate/binder/water blend may then be formed into any desired shape. The shape hardens to form an article. Heating, either in a kiln or at use temperature, produces an oxide-bonded article.

A preferred use of the binder is in a castable refractory formulation. The binder may also be used in other types of refractories, for example, plastic materials, ram materials, bricks, and pressed shapes. One skilled in the art would appreciate the need to adjust for pot life and forming sequences to achieve a set of the bond in a proper time interval.

In a specific embodiment, refractory aggregate comprising fireclay aggregate and fumed silica is combined with 1 wt. % aluminum powder, 0.5 wt. % magnesia buffer, and 0.2 wt. % deflocculant. Water is added at 5 wt. % and formed into the desired shape. Control of pH reduces hydrogen evolution and the resulting porosity. Firing produces a dense oxide-based article with reduced porosity.

### DETAILED DESCRIPTION OF THE INVENTION

The mixture of the invention contains an aggregate and a substance yielding a pH buffer. The mixture of the invention yields a refractory composition without the use of cement. Cement-free mixtures according to the present invention contain less than the 3.3 wt % cement of the comparative example presented herein and may contain less than 0.2 wt % cement.

A binder may be used in the present invention in combination with ceramic aggregates, particularly refractory ceramic aggregates. The binder is cement-free and may consist essentially of metal powder. A mixture is formed comprising aggregate, metal powder binder and a pH buffer. A sufficient amount of water is added to the mixture. The mixture including the water is then formed into an article. Unlike cement-based binders, the present binder has refractoriness similar to or greater than the aggregate. Physical properties of an article made using the metal binder can also exceed articles made using traditional binder systems.

The invention is not limited to any particular ceramic aggregate, that is, the ceramic aggregate may be of any suitable chemical compositions, or particle sizes, shapes or distributions. Common aggregates include silica, zirconia, silicon carbide, alumina, magnesia, spinels, and their combinations. The aggregates may include fumed materials. In one embodiment of the invention, the aggregate contains fumed silica and a substance, such as alumina, magnesia, zirconia or non-cementitious calcium compounds, or combinations of these materials, yielding a pH buffer. The application in which the refractory article is to be used largely dictates the composition of the refractor aggregate. The bond is likewise suitable to produce castables for use in non-refractory applications. Suitable metals and aggregates can be employed to produce castables that can be used in ambient temperature structures. Typical applications are civil engineering structures (bridges, buildings, roads, etc), specialty concrete, and repair materials.

The binder may consist essentially of metal powder and contains no cement, such as calcium aluminate cement, which typically has lower strength and refractoriness than ceramic aggregate. The metal powder includes any metal capable of reacting with water to form a matrix between aggregate particles. The matrix may be, for example, a hydroxide gel. The metal powder should not be too reactive so that the rate of reaction with water is uncontrollable. Reactivity depends on at least the pH of the solution, the metal used, and the metal's size and shape. For example, alkali metals react violently with water regardless of pH. The metal powder must also not be too inert so that the set time is excessive or non-existent. Unreactive metals include the noble metals and other transition metals having a low chemical potential.

Suitable metals for the binder include, but are not limited to, aluminum, magnesium, silicon, iron, chromium, zirconium, their alloys and mixtures. The reactivity of these metals may be controlled by adjusting various factors, including pH and the particle size of the metal powder. A gel forms after mixing with water that binds the article until, at elevated temperature, an oxide bond forms that binds together the aggregate. The oxide bond is more refractory than calcium aluminate cement and many other bonding technologies.

The pH of the aggregate/binder/water mixture must be controlled so that the evolution of hydrogen gas is kept within acceptable limits. Hydrogen generation can be extremely and explosively exothermic. Additional deleterious effects of hydrogen evolution include increased porosity and premature decomposition of a hydroxide gel matrix. The pH needed to control hydrogen evolution will depend on the metal being used. This pH is calculable and is based on the chemical potential of the metal. An aggregate can be chosen that is capable of maintaining pH. Alternatively, a buffer may be necessary to maintain the desired pH. Suitable buffers are known to one skilled in the art and include magnesia, alumina, zirconia and non-cementitious calcium compounds, and combinations of these substances. Preferably, the buffer will be itself refractory or will decompose and volatize at use temperatures. A sequestering agent, such as citric acid or boric acid may be added to control set times. The invention may be practiced with a mixture having a pH no greater than 10.0.

The kinetics of the metal/water reaction is also controlled by the particle size of the metal powder. Reactivity of the metal powder is proportional to the available surface area. Greater surface area results in greater reactivity. An effective particle size of the metal powder is −70 mesh (212 microns) or smaller. Too large a particle size limits reactivity, and too small a particle size could make the kinetics of the reaction difficult to control. A convenient size is −200 mesh (75 microns) to −325 mesh (45 microns). Particle size is only one means of controlling surface area. The shape or texture of the metal powder could also be changed. Alternatively, the surface of the metal powder could be coated with a passivating agent, such as a polymer, wax or oxide.

The amount of metal binder varies with, among other things, the intended application, the refractory aggregate, the metal, and the expected speed of set. The binder will typically range from 0.5 wt. % to 5 wt. % of the mixture. As little as 0.1 wt. % has been effective and as much as 10 wt. % is contemplated. Lower amounts of binder can reduce the speed of set and the strength of the finished article. A sufficient amount of binder should be included in the mixture to achieve the desired properties. Higher amounts of binder increase costs and the risk of spontaneous reactions. For aluminum metal, a concentration of about 1 wt. % works satisfactorily for castable applications. If certain aggregate components, such as fumed silica, are used, the mixture of the invention can be produced without the use of metal binder. Specifically, mixtures according to the invention can be prepared without aluminum alloy powder.

Optionally, various additives may be included to improve physical properties during or after preparation of the article. A deflocculant may be added to improve flow and reduce water requirements. Carbon, for example, as carbon black or pitch, may be added to resist slag penetration during service. Anti-oxidants, such as boron carbide or silicon, protect carbon from oxidation. Other additives are well known to one skilled in the art. Example

Two castable aggregate/binder mixtures were produced. Both mixtures were intended as refractory linings for blast furnace iron troughs and runners. A first mixture was a typical “ultra-low” cement castable comprising 74 wt. % alumina, 17.5 wt. % silicon carbide, 3.3 wt. % calcium aluminate cement, 2.5 wt. % fumed silica, and 0.2 wt. % metal powder. A second mixture was a cement-free composition of the present invention comprising 69 wt. % alumina, 22.5 wt. % silicon carbide, 6 wt. % fumed silica, 0.75 wt. % silicon and 0.5 wt. % aluminum.

Water was added to both mixtures. The cement-based mixture required from 4.25%-6.25 wt. % water to obtain an ASTM C-1445 flow from 20-100%. The cement-free mixture required only 2.75-3.75 wt % water to obtain 20-100% flow. The cement-free composition required about one-half as much water to achieve a desired flow.

The mixture and water were allowed to set. During setting, the cement in the first mixture increased the pH to over 10.0, thereby favoring a hydrolysis reaction between aluminum powder and water. The reaction produced hydrogen and heat. Hydrogen degassed from the mixture and produced pores and voids. The heat accelerated drying time. In contrast, the pH of the second mixture remained below 10.0 because, in part, of the absence of cement. Hydrolysis was thereby checked as was outgassing. Density of the cement-free mixture was higher than the cement-based mixture. Porosity of the dried ultra-low cement mixture varied from 16-24%. Porosity of the cement-free mixture was 13-15%.

The ultra-low cement and cement-free mixtures should be dried before use to remove any residual water. Advantageously, as described above, the amount of water needed in the cement-free article is significantly less than the cement-based mixture, so drying is facilitated. Once dried and brought to a use temperature of over 800 C., the cement-free material showed higher hot modulus of rupture (HMOR) than the ultra-low cement material. HMOR was performed according to ASTM C-583. HMOR of cement-free castable was 10.3, 20.7, 8.6 and 2.8 MPa at 800, 1100, 1370 and 1480° C., respectively. The ultra-low cement castable has lower HMOR at every temperature, that is, 6.2, 4.8, 5.5 and 2.1 MPa at 800, 1100, 1370 and 1480 C., respectively.

Although the present invention has been described in relation to particular embodiments thereof, many other variations and modifications and other uses will become apparent to those skilled in the art. The present invention is not to be limited by the specific disclosure herein.

What is claimed

1 A refractory mixture for the production of a refractory article characterized by the absence of cement and comprising:
a) a pH buffer; and
b) a refractory aggregate comprising fumed silica and/or metal binder.

2. The refractory mixture of claim 1, characterized in that the pH buffer comprises zirconia, alumina, magnesia or a non-cementitious calcium compound, or combinations thereof.

3. The refractory mixture of claims 1-2, characterized by the mixture including a binder comprising metal having a particle size of no greater than 70 mesh.

4. The refractory mixture of claim 3, characterized by the presence of least 65 wt. % refractory aggregate and 0.1-10 wt. % metal.

5. The refractory mixture of claim 1, characterized in that the metal comprises aluminum, silicon, magnesium, chromium, zirconium or iron, or combinations or alloys thereof.

6. The refractory mixture of claim 1, characterized in that the metal comprises silicon.

7. The refractory mixture of claim 1, characterized by a pH no greater than 10.0, when mixed with water to create a mixture with a desired flowability.

8. The refractory article formed from the mixture of claim 1, made from a process characterized by:
a) mixing the refractory aggregate and pH buffer;
b) adding a sufficient amount of water to create a mixture with a desired flowability and a pH;
c) forming the mixture into an article;
d) allowing the article to set; and
e) drying the shape to remove excess water.

9. The refractory article of claim 8, characterized by heating the article to use temperature after drying.

10. The refractory article of claims 8-9, characterized in that the pH buffer is zirconia, alumina, magnesia or a non-cementitious calcium compound, or combinations thereof.

11. The refractory article of claim 8, characterized by mixing the refractory aggregate with a binder comprising metal having a particle size of no greater than 70 mesh.

12. The refractory article of claim 8, characterized in that the metal is aluminum, silicon, magnesium, chromium, zirconium and/or iron, or combinations or alloys thereof.

13. The refractory article of claim 8, characterized in that the metal is silicon.

14. The refractory article of claim 8, characterized in that the pH is no greater than 10.0.

15. The method of manufacturing the article of claim 1, characterized by:
a) mixing the refractory aggregate and pH buffer;
b) adding a sufficient amount of water to create a mixture with desired flowability;
c) forming the mixture into an article;
d) allowing the article to set; and
e) drying the shape to remove excess water.

16. The method of claim 15, characterized in that the pH buffer comprises zirconia, alumina, magnesia or a non-cementitious calcium compound, or combinations thereof.

17. The method of claim 15-16, characterized by mixing the refractory aggregate with a binder comprising metal having a particle size of no greater than 70 mesh.

18. The method of claim 15, characterized in that the metal comprises aluminum, silicon, magnesium, chromium, zirconium and/or iron, or combinations or alloys thereof.

19. The method of claim 15, characterized in that the metal comprises silicon.

20. The method of claim 15, characterized in that the pH is no greater than 10.0
